(19) United States
(12) Patent Application Publication
(10) Pub. No.: US 2005/0256741 A1
(43) Pub. Date: Nov. 17, 2005

(54) Mediated data encryption for longitudinal patient level databases

(76) Inventors: Mark E. Kohan, Downingtown, PA (US); Clinton J. Wolfe, Malvern, PA (US)

Correspondence Address: BAKER & BOTTS, 30 ROCKEFELLER PLAZA, NEW YORK, NY, 10112, US

(21) Appl. No.: 11/122,565

(22) Filed: May 5, 2005

Related U.S. Application Data
(60) Provisional application No. 60/568,455, filed on May 5, 2004.
(60) Provisional application No. 60/572,161, filed on May 17, 2004.
(60) Provisional application No. 60/571,962, filed on May 17, 2004.
(60) Provisional application No. 60/572,064, filed on May 17, 2004.
(60) Provisional application No. 60/572,264, filed on May 17, 2004.

(51) Int. Cl. G06F 17/60

(52) U.S. Cl. 705/2

(57) ABSTRACT

A system and method for the assembly of a longitudinally linked database of patient healthcare data records involve a neutral implementation partner to ensure that sensitive patient-identifying information contained in the data records is secure at all times. The implementation partner is deployed to mediate processing of the data records in a secure environment, which is inaccessible to unauthorized parties including data supplier and database facility personnel. At data supplier sites, the implementation partner mediates processing of the data records so that the patient-identifying attributes in the data records are encrypted before they are transmitted to a common longitudinal database facility. At the common longitudinal database facility, the implementation partner mediates processing of the data records so that internal tags are assigned to data records based on the values of the encrypted patient-identifying attributes. The internal tags are used to longitudinally link the encrypted data records in a statistically meaningful manner. The implementation partner may be any combination of software, hardware and organizational entities.

### CROSS REFERENCE TO RELATED APPLICATIONS

This application claims the benefit of U.S. provisional patent application Ser. No. 60/568,455 filed May 5, 2004, U.S. provisional patent application Ser. No. 60/572,161 filed May 17, 2004, U.S. provisional patent application Ser. No. 60/571,962 filed May 17, 2004, U.S. provisional patent application Ser. No. 60/572,064 filed May 17, 2004, and U.S. provisional patent application Ser. No. 60/572,264 filed May 17, 2004, all of which applications are hereby incorporated by reference in their entireties herein.

### BACKGROUND OF THE INVENTION

The present invention relates to the management of personal health information or data on individuals. The invention in particular relates to the assembly and use of such data in a longitudinal database in manner, which maintains individual privacy.

Electronic databases of patient health records are useful for both commercial and non-commercial purposes. Longitudinal (life time) patient record databases are used, for example, in epidemiological or other population-based research studies for analysis of time-trends, causality, or incidence of health events in a population. The patient records assembled in a longitudinal database are likely to be collected from a multiple number of sources and in a variety of formats. An obvious source of patient health records is the modern health insurance industry, which relies extensively on electronically-communicated patient transaction records for administering insurance payments to medical service providers. The medical service providers (e.g., pharmacies, hospitals or clinics) or their agents (e.g., data clearing houses, processors or vendors) supply individually identified patient transaction records to the insurance industry for compensation. The patient transaction records, in addition to personal information data fields or attributes, may contain other information concerning, for example, diagnosis, prescriptions, treatment or outcome. Such information acquired from multiple sources can be valuable for longitudinal studies. However, to preserve individual privacy, it is important that the patient records integrated to a longitudinal database facility are “anonymized” or “de-identified”.

A data supplier or source can remove or encrypt personal information data fields or attributes (e.g., name, social security number, home address, zip code, etc.) in a patient transaction record before transmission to preserve patient privacy. The encryption or standardization of certain personal information data fields to preserve patient privacy is now mandated by statute and government regulation. Concern for the civil rights of individuals has led to government regulation of the collection and use of personal health data for electronic transactions. For example, regulations issued under the Health Insurance Portability and Accountability Act of 1996 (HIPAA), involve elaborate rules to safeguard the security and confidentiality of personal health information. The HIPAA regulations cover entities such as health plans, health care clearinghouses, and those health care providers who conduct certain financial and administrative transactions (e.g., enrollment, billing and eligibility verification) electronically. (See e.g., http://www.hhs.gov/ocr/hipaa). Commonly invented and co-assigned patent application Ser. No. 10/892,021, “Data Privacy Management Systems and Methods”, filed Jul. 15, 2004 (Attorney Docket No. AP35879), which is hereby incorporated by reference in its entirety herein, describes systems and methods of collecting and using personal health information in standardized format to comply with government mandated HIPAA regulations or other sets of privacy rules.

For further minimization of the risk of breach of patient privacy, it may be desirable to strip or remove all patient identification information from patient records that are used to construct a longitudinal database. However, stripping data records of patient identification information to completely “anonymize” them can be incompatible with the construction of the longitudinal database in which the stored data records or fields are necessarily updated individual patient-by-patient.

Consideration is now being given to integrating “anonymized” or “de-identified” patient records from diverse data sources in a longitudinal database. In particular, attention is paid to systems and methods for preserving patient privacy in a data collection and processing enterprise for assembling the longitudinal database where the enterprise may extend over several data supplier sites and the longitudinal database facility.

### SUMMARY OF THE INVENTION

Systems and methods are provided for managing the privacy of individuals whose healthcare data records are assembled in a longitudinally linked database. The systems and methods may be implemented in a data collection and processing enterprise, which may be geographically diverse and which may involve a several data suppliers and a common longitudinal database assembly facility.

The systems and methods involve a neutral third party (i.e. an implementation partner) to mediate the processing of data records at data supplier sites and at a common longitudinal database facility where the multi-source data records are assembled in a database. The systems and methods are designed so that unauthorized parties cannot have access to sensitive patient-identifying attributes or information in the data records being processed. The data records are first processed at the data supplier sites so that sensitive data attributes are doubly encrypted with two consecutive levels of encryption before the data records are transmitted to the longitudinal database facility. These doubly encrypted data records are processed at the longitudinal database facility to remove one level of encryption in preparation for integrating the data records into a longitudinal database at an individual level. The data encryption and decryption at the supplier sites and the longitudinal database facility are controlled by the neutral third party operating in a secure processing environment, which reduces or eliminates the risk of deliberate or inadvertent release of the sensitive patient identifying information.

Further features of the invention, its nature and various advantages will be more apparent from the accompanying drawings and the following detailed description.

### BRIEF DESCRIPTION OF THE DRAWING

FIG. 1, which is reproduced from U.S. patent application Ser. No. ______, is a block diagram of an exemplary system for assembling a longitudinal database from multi-sourced patient data records. The privacy management procedures described herein may be implemented in the system of FIG. 1, in accordance with the principles of the present invention.

### DESCRIPTION OF THE INVENTION

Systems and methods are provided for managing and ensuring patient privacy in the assembly of a longitudinally linked database of patient healthcare records. The systems and methods may be implemented in a data collection and processing enterprise, which may be geographically diverse and which may involve several data suppliers and other parties. The systems and methods may, for example, be implemented in conjunction with the exemplary longitudinal database assembly system described in commonly owned patent application Ser. No. ______, filed May 5, 2005 (Atty. Docket No. AP36247), which is hereby incorporated by reference herein in its entirety.

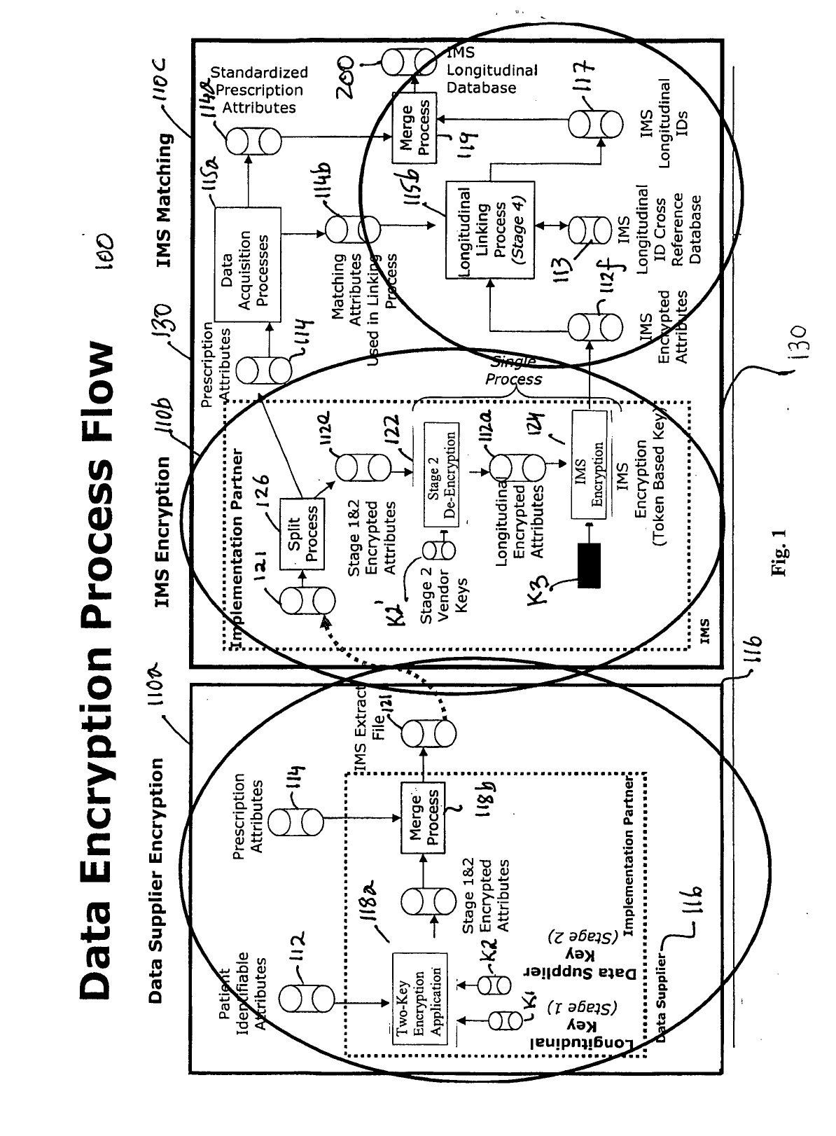

The referenced patent application discloses a solution, which allows patient data records acquired from multiple sources to be integrated each individual patient by patient into a longitudinal database without creating any risk of breaching of patient privacy. The solution uses a two-step encryption process using multiple encryption keys to encrypt sensitive patient-identifying information in the data records. (See e.g., FIG. 1). The encryption process includes encryption steps performed at the data supplier sites (e.g., site 116, FIG. 1) and also encryption/decryption steps performed at a longitudinal database facility (“LDF”) (e.g., site 130, FIG. 1). At the first step, each DS encrypts selected data fields (e.g., patient-identifying attributes and/or other standard attribute data fields) in the patient records to convert the patient records into a first “anonymized” format. With continued reference to FIG. 1, each DS uses two keys (i.e., a DS-specific key K2, and a common longitudinal key K1 associated with a specific LDF) to doubly encrypt the selected data fields. The doubly encrypted data records are transmitted to the LDF site. The data records are then processed into a second anonymized format, which is designed to allow the data records to be linked individual patient by patient without recovering the original unencrypted patient identification information. For this purpose, the doubly encrypted data fields in the patient records received from the DS are partially de-crypted using a specific DS key K2′ (such that the doubly encrypted data fields still retain the common longitudinal key encryption). A third key (e.g., a token based key, K3) may be used to further encrypt the data records, which include the now-singly (common longitudinal key) encrypted data fields or attributes, for use in a longitudinally linked database. Longitudinal identifiers (IDs) or dummy labels that are internal to the longitudinal database facility may be used to tag the data records so that they can be matched and linked individual ID-by-ID in the longitudinal database.

In one embodiment of invention, the privacy management procedures and models involve a business mechanism in the two-step encryption processes so that no single party (i.e., neither the data suppliers nor the LDF) has full access to the entire data process or flow. Any risk of intentional or inadvertent release of patient-identifying information, for example, to LDF personnel or users, is thereby minimized.

The business mechanism may involve hardware, software and/or third parties. The business mechanism is invoked to conduct portions of the two-step encryption processes in a secure environment, which is inaccessible to the data suppliers, the LDF, and other unauthorized parties. The business mechanism may include one or more software applications that may be deployed the data supplier sites and/or the LDF. The business mechanism may include only software configurations, or may include both software and hardware environment configurations at data supplier sites and the LDF. In an exemplary implementation, tens or hundreds of data supplier sites and the LDF may be covered by the business mechanism.

The business mechanism involves deployment and support of common data encryption applications across a plurality of data supplier sites and the LDF. The deployed common data encryption applications may include applications for generating, using and securing several encryption and/or decryption keys. The business mechanism is configured to provide or supervise key generation, supply, administration and security functions.

The longitudinal databases created or maintained using the principles of the present invention may be utilized to provide information solutions, for example, to the pharmaceutical and healthcare industries. The longitudinal databases may transform billions of pharmaceutical records collected from thousands of sources worldwide into valuable strategic insights for clients. The business mechanism utilized in creating the longitudinal databases is designed to protecting the privacy and security of all collected healthcare information.

An exemplary longitudinal database may include data sourced from U.S.-based prescription data suppliers. Market intelligence and analyses gleaned from the longitudinal database can provide customers (e.g., pharmaceutical drug R&D organizations or manufacturers) critical technical and business facts at every stage of the pharmaceutical life cycle ranging from the early stages of research and development through product launch, product maturation and patent expiration stages. The market intelligence and analyses may, for example, include targeted forecasts and trend analyses, customized product-introduction information, pricing and promotional parameters and guidelines, competitive comparisons, market share data, evaluations of sales-force prospects and productivity, and market audits segmented by product, manufacturer, geography and healthcare sector, as well as by inventory and distribution channels.

In one embodiment, the business mechanism involves a neutral entity, e.g., third party implementation partner (“IP”), to conduct portions of the two-step encryption processes in a secure environment. The IP may be a suitable third party, who, for example, is adept at developing relationships with the data suppliers and the LDF. The IP may have expertise in implementing onsite applications, and may be able to provide case examples from existing clients. The case examples may include implementations across a large number of non-standard environments. The IP may have the capability to provide application support in geographically diverse locations (e.g., across the United States) and may have a suitable organizational structure to provide that support. The IP may be required to have a working understanding or command of HIPAA regulations and other standards related to collection and handling of private health information.

The functions of the IP may be understood with reference to the systems and methods for constructing a longitudinal database, which are described in the referenced patent application Ser. No. ______. (See e.g., FIG. 1). The processes for constructing the longitudinal database according to the referenced patent application may include three sequential components or stages 110a, 110b and 110c. In first stage 110a, critical data encryption processes are conducted at data supplier sites. The second (110b) and third stage (110c) processes may be conducted at a common LDF site 130, which is supplied with encrypted data records by multiple data suppliers. In second stage 110b, vendor-specific encrypted data is processed into LDF-encrypted data, which can be longitudinally linked across data suppliers. At final stage 110c, the LDF-encrypted data is processed using various probabilistic and deterministic matching algorithms, which assign unique tags to the encrypted data records. The assigned tags, which may be viewed as pseudo or fictitious patient identifiers (“ID”), do not include explicit patient identification information, but can be effectively used to longitudinally link the LDF-encrypted data records in a statistically valid manner to create the longitudinal database. Exemplary matching algorithms are described in co-pending patent application patent application Ser. No. ______, filed May 5, 2005 (Atty. Docket No. AP36251), which is incorporated by reference herein in its entirety.

The matching algorithms may assign a particular tag to a data record based on the encrypted values of a select set of personally identifiable data attributes in the data record. The processes for constructing the longitudinal database require that at least the selected set of attributes must be acquired and encrypted in the data records transmitted by the data suppliers to the LDF. In accordance with the present invention, the IP may be utilized to assist the data suppliers in defining and implementing processes for the acquisition, encryption and transmission of the data records, which include the select set of data attributes. A first data supplier process may be used for the identification and acquisition of the necessary attributes from the data supplier's databases/files. Once the attributes are acquired, they may processed through encryption applications, which may be coded in “C” or “JAVA.” The encryption applications may standardize the attributes and further encrypt them using a dual encryption process using a universal longitudinal encryption key and a vendor-specific encryption key. The encrypted attribute output then can be transmitted to the LDF in a secure manner as either part of an existing data feed or as a separate data transmission from the data supplier. Suitable applications/environments to merge the data and/or to send the encrypted data file may be defined. The IP may be utilized to assist the data suppliers in implementing the data supplier components and for providing on-going production support to the data suppliers.

After the data records are received at the LDF, the encrypted data attributes can processed through a secure encryption environment to generate LDF encrypted attributes. These “new” LDF encrypted attributes may be designed to be linkable across data sources. The secure encryption environment, which contains the encryption keys and software, is managed or supervised by the IP. The IP ensures that the LDF has no access to this secure encryption environment. The encrypted attributes resulting from this stage can be processed in the final stage of the process by a matching application, which assigns longitudinal patient identifiers (“IDs”) to tag data records for incorporation in the longitudinal database.

The IP may have ownership of the encryption applications utilized. The IP may deploy and manage these and other applications in both the data supplier and the LDF environments. A typical data supplier site deployment may include a startup period during which encryption applications and processes are installed, tested, and during which the data supplier and/or the IP begin “pushing” encrypted data attributes back to LDF. The IP may provide support to reduce data supplier-to-data supplier process variability that may result from variations, for example, in data supplier technical platforms or environments. The IP may provide this support during the startup period to bring the data supplier's processes up to acceptable standards.

After processes for feeding standardized data records from the data supplier to the LDF have been established (e.g., after the startup period), the IP may continue to provide maintenance, application updates, help-desk support/issue resolution, and potential process audit support.

The IP may also may support deploy and manage the portions of the encryption applications at the LDF or at an intermediary site. For example, the IP may install the encryption application, coordinate the delivery of encrypted data to the encryption application, and ensure security of the encryption application in the LDF environment. The IP may continue to provide maintenance, application updates, help-desk support/issue resolution, and potential process audit support after the initial installation.

The exemplary functions, which may be performed by an IP, include:
Installation and testing of the encryption application at data supplier sites.
Assisting the supplier in acquiring the data from wherever it is stored in their environment, and presenting it to the implemented encryption application.
Working with the data supplier to ensure delivery of the encrypted data results to the LDF.
Getting the “LDF side” of the encryption application installed and fully functional
Coordinating the delivery of encrypted data to the encryption application.
Ensuring security of the encryption application and data records in the LDF environment.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

1. A process for assembling a longitudinally linked database from individual patient healthcare transaction data records, the process comprising the steps of:
(a) deploying an implementation partner (IP) to mediate processing of acquired data records having patient-identifying attributes and non-identifying attributes at a data supplier site, whereby at least the patient-identifying attributes in the data records are encrypted so that the data records can be securely transmitted to a longitudinal database facility (LDF);
(b) receiving the encrypted data records at the LDF; and
(c) deploying the IP to mediate processing of the received data records, whereby LDF identifiers (IDs) are assigned to the data records based on the values of the encrypted patient-identifying attributes in the data records, and whereby the encrypted data records can be linked longitudinally ID by ID,
wherein in steps (a) and (c) the processing of the data records is performed in a secure processing environment that is accessible only to the IP.

2. The process of claim 1 wherein the processing of the acquired data records in step (a) comprises:
(d) encrypting the patient-identifying attributes in the data records using a first encryption key specific to the LDF; and
(e) further encrypting the patient-identifying attributes with a second encryption key specific to the data supplier site.

3. The process of claim 2 wherein the processing of the received data records in step (c) comprises:
(f) partially decrypting the received data records so that the patient-identifying attributes retain only the step (d) encryption by the first encryption key specific to the LDF.

4. The process of claim 3 further comprising the step (g) of additionally encrypting the attributes after step (f) using a third encryption key.

5. The process of claim 3 further comprising the step (h) of using an attribute-matching algorithm to assign an LDF identifier (ID) to the encrypted data records.

6. The process of claim 5 further comprising the step (i) of linking the encrypted data records ID by ID, whereby the longitudinally linked database is formed.

7. The method of claim 1 wherein the IP consists one of software, hardware, a neutral entity, and any combination thereof.

8. The process of claim 1 further comprising the step of preprocessing the acquired data records to place their data fields in a standard format.

9. The process of claim 1 wherein steps (a) and (c) comprise provision of encryption/decryption keys by the IP.

10. The process of claim 1 wherein mediation by the IP in steps (a) and (c) comprises provision of a secure processing environment that limits unauthorized access to patient-identifying attribute information in the data records.

11. A system for assembling a longitudinally linked database from individual patient healthcare transaction data records received from multiple data suppliers by a longitudinal database facility (LDF), the system comprising:
an implementation partner (IP) who mediates processing of data records having patient-identifying attributes and non-identifying attributes at a data supplier site, whereby at least the patient-identifying attributes in the data records are encrypted so that the data records can be securely transmitted to the LDF, and who further mediates processing of the received data records at the LDF, whereby identifiers (IDs) are assigned to data records based on the values of the encrypted patient-identifying attributes in the data records, and whereby the encrypted data records can be linked longitudinally ID by ID at the LDF; and
a secure data processing environment extending over the data suppler site and the LDF that is accessible only to the IP.

12. The system of claim 11 wherein the IP mediates the processing of the data records at a data supplier site so that attributes in the data records are placed in a standard format.

13. The system of claim 11 wherein the IP mediates the processing of the data records at a data supplier site so that:
(a) the patient-identifying attributes in the data records are encrypted using a first encryption key specific to the LDF; and
(b) the patient-identifying attributes in the data records are further encrypted with a second encryption key specific to the data supplier site.

14. The system of claim 13 wherein the IP mediates the processing of the received data records at the LDF so that the received data records are partially decrypted, whereby the patient-identifying attributes retain only the encryption by the first encryption key specific to the LDF.

15. The system of claim 13 wherein the IP mediates the processing of the received data records at the LDF so that the received data records are further encrypted using a third encryption key.

16. The system of claim 11 comprising an attribute-matching algorithm designed to assign IDs to the encrypted data records based on the values of the encrypted attributes.

17. The system of claim 11 wherein the IP consists one of software, hardware, a neutral entity, and any combination thereof.

18. The system of claim 11 wherein the IP provides encryption/decryption keys.

19. The system of claim 11 further comprising a cross database of IDs and corresponding attributes.
